(19) United States
(12) Patent Application Publication
(10) Pub. No.: US 2014/0022229 A1
(43) Pub. Date: Jan. 23, 2014

(54) GATE DRIVER AND DISPLAY DEVICE INCLUDING THE SAME

(71) Applicant: Samsung Display Co., Ltd., Yongin-city (KR)

(72) Inventor: Deok Jun Choi, Yongin-city (KR)

(21) Appl. No.: 13/936,466

(22) Filed: Jul. 8, 2013

(30) Foreign Application Priority Data
Jul. 17, 2012 (KR) 10-2012-0077836

(51) Int. Cl. G09G 3/36

(52) U.S. Cl. CPC G09G 3/3696
USPC 345/212; 327/109

(57) ABSTRACT

Disclosed are a gate driver and a display device including the same. The gate driver comprises a register which stores data, a gate driving circuit which generates driving signals based on the data stored in the register, and one or more output terminals which output the driving signals generated by the gate driving circuit.

### CROSS-REFERENCE TO RELATED APPLICATIONS

This application claims priority from Korean Patent Application No. 10-2012-0077836 filed on Jul. 17, 2012 in the Korean Intellectual Property Office, the disclosure of which is incorporated herein by reference in its entirety.

### BACKGROUND

1. Field

The present invention relates to a gate driver and a display device including the same, and more particularly, to a gate driver which includes a settable register and outputs an output signal through each output terminal using the register and a display device including the gate driver.

2. Description of the Related Technology

The development of information and communications technology and the diverse needs of the information society are causing an increase in the demands for displays. Cathode ray tubes (CRTs), which were once the most common type of display devices, are being replaced with flat panel displays (FPDs) to meet the demands for more compact and less power-consuming display devices. Some of the most widely used FPDs include electroluminescent displays (ELDs), liquid crystal displays (LCDs) (TFT-LCDs, TN/STN), plasma display panels, and organic electroluminescent displays.

An LCD, which is one type of FPD, is a display device that displays an image by controlling the transmittance of light incident from a light source using optical anisotropy of liquid crystal molecules and polarizing characteristics of a polarizer. LCDs can be made to be lighter and thinner and provide higher resolution and larger screens. Due to low power consumption of LCDs, the scope of applications of the LCDs is expanding rapidly.

An LCD may be divided into a display area which displays images and a peripheral area which is located around the display area and transmits electrical signals to the display area.

To display an image corresponding to input data, the LCD may adjust the luminance of each pixel by converting the input data into a data signal using a data driving unit and controlling the scanning of each pixel using a gate driving unit. The data driving unit and the gate driving unit may operate according to the timing determined by a control signal of a timing control unit. Each pixel of the LCD may include a liquid crystal capacitor coupled to a gate line and charged with an image data voltage and a storage capacitor coupled to the liquid crystal capacitor and maintaining the voltage charged in the liquid crystal capacitor. An image may be displayed according to the voltage charged in the liquid crystal capacitor.

### SUMMARY OF CERTAIN INVENTIVE ASPECTS

Aspects of the present invention provide a gate driver which can output an output signal through each output terminal and a display device including the gate driver.

Aspects of the present invention also provide a highly compatible gate driver and a display device including the gate driver.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a gate driver comprising a register which is configured to store data, a gate driving circuit which is configured to generate driving signals based on the data stored in the register, and one or more output terminals each configured to output a driving signal generated by the gate driving circuit.

The register may have a size of 1 bit to 32 bytes.

The gate driving circuit may be configured to generate a driving signal that is to be output through each of the output terminals based on data corresponding to each of the output terminals from among the data stored in the register.

The gate driving circuit may be configured to generate a driving signal that is to be output through an output terminal based on data corresponding to the output terminal from among the data stored in the register, wherein the data corresponding to the output terminal has a size of 1 bit to 8 bits.

The gate driving circuit may be configured to generate a driving signal that is to be output through an output terminal based on data corresponding to the output terminal from among the data stored in the register, wherein when the data corresponding to the output terminal is changed to a different value, the driving signal output through the output terminal is changed to a different type.

The gate driver may comprise two or more output terminals, wherein one or more of the output terminals may be configured to output two or more different types of driving signals based on the data stored in the register, and one or more of the output terminals may be configured to output one type of driving signal regardless of the data stored in the register.

The gate driving circuit may be configured to generate a driving signal that is to be output through a first output terminal based on first data from among the data stored in the register and to generate a driving signal that is to be output through a second output terminal based on second data from among the data stored in the register, wherein the first data and the second data have different sizes.

According to another aspect of the present invention, there is provided a gate driver comprising a register which is configured to store data, a gate driving circuit which is configured to generate two or more different types of driving signals based on the data stored in the register, and one or more output terminals which are configured to output the driving signals generated by the gate driving circuit and output two or more different types of driving signals based on the data stored in the register.

According to still another aspect of the present invention, there is provided a display device comprising, a liquid crystal panel which comprises one or more gate lines, one or more data lines, and one or more pixels disposed in regions where the gate lines intersect the data lines, a timing control unit which is configured to generate a control signal for driving the liquid crystal panel, a gate driving unit which is configured to receive the control signal and to output a gate signal to each of the gate lines in response to the control signal, and a data driving unit which is configured to receive the control signal and to apply a data voltage to each of the data lines in response to the control signal, wherein the gate driving unit comprises a register which is configured to store data, a gate driving circuit which is configured to generate driving signals based on the data stored in the register, and one or more output terminals which are configured to output the driving signals generated by the gate driving circuit.

One or more of the output terminals output two or more different types of driving signals based on the data stored in the register.

The gate driving unit may comprise two or more output terminals, wherein one or more of the output terminals are configured to output two or more different types of driving signals based on the data stored in the register, and one or more of the output terminals are configured to output one type of driving signal regardless of the data stored in the register.

The gate driving circuit is configured to generate a driving signal that is to be output through a first output terminal based on first data from among the data stored in the register and to generate a driving signal that is to be output through a second output terminal based on second data from among the data stored in the register, wherein the first data and the second data have different sizes.

According to still another aspect of the present invention, there is provided a display device comprising a liquid crystal panel which comprises one or more gate lines, one or more data lines, and one or more pixels disposed in regions where the gate lines intersect the data lines, a timing control unit which is configured to generate a control signal for driving the liquid crystal panel, a gate driving unit which is configured to receive the control signal and to output a gate signal to each of the gate lines in response to the control signal, and a data driving unit which is configured to receive the control signal and to apply a data voltage to each of the data lines in response to the control signal, wherein the gate driving unit comprises a register which is configured to store data, a gate driving circuit which is configured to generate two or more different types of driving signals based on the data stored in the register, and one or more output terminals which are configured to output the driving signals generated by the gate driving circuit.

The one or more output terminals may further be configured to output two or more different types of driving signals based on the data stored in the register.

### BRIEF DESCRIPTION OF THE DRAWINGS

The above and other aspects and features of the present invention will become more apparent by describing in detail certain embodiments thereof with reference to the attached drawings, in which:

FIG. 1 is a schematic circuit diagram of a display device according to an embodiment of the present invention;

FIG. 2 is a circuit diagram of a pixel according to an embodiment of the present invention;

FIG. 3 is a block diagram of a gate driver according to an embodiment of the present invention;

FIG. 4 is a conceptual diagram illustrating a process of generating a driving signal that is to be output through each output terminal of the gate driver according to an embodiment of the present invention;

FIG. 5 is a table showing a driving signal output from each output terminal of the gate driver based on data stored in a register according to an embodiment of the present invention; and

FIG. 6 is a table showing a default value of a driving signal output from each output terminal of the gate driver according to an embodiment of the present invention.

### DETAILED DESCRIPTION OF CERTAIN INVENTIVE EMBODIMENTS

Advantages and features of the present invention and methods of accomplishing the same may be understood more readily by reference to the following detailed description of certain embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Thus, in some embodiments, well-known structures and devices are not shown in order not to obscure the description of the invention with unnecessary detail. Like numbers generally refer to like elements throughout. In the drawings, the thickness of layers and regions may be exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views of the invention. Accordingly, the sample views may be modified depending on manufacturing technologies and/or tolerances. Therefore, the embodiments of the invention are not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the invention.

A conventional gate driver outputs a constant output signal through each output terminal. Therefore, to drive an LCD, circuits are designed based on each output terminal thereof and an output signal output from each output terminal. However, some types of gate drivers may not be compatible with existing production facilities. In this case, if an error occurs during the operation of an LCD due to the compatibility problem, a gate driver has to be replaced.

A gate driver and a display device including the same according to an embodiment of the present invention will now be described with reference to the attached drawings.

A display device 100 according to an embodiment of the present invention can be implemented as any one of various types of display devices including a liquid crystal display (LCD), an organic electroluminescent display, a plasma display panel, and a field emission display. It will hereinafter be assumed that the display device 100 is implemented as an LCD. However, the display device 100 is not limited to the LCD, and a gate driver according to an embodiment of the present invention is applicable to various types of display devices.

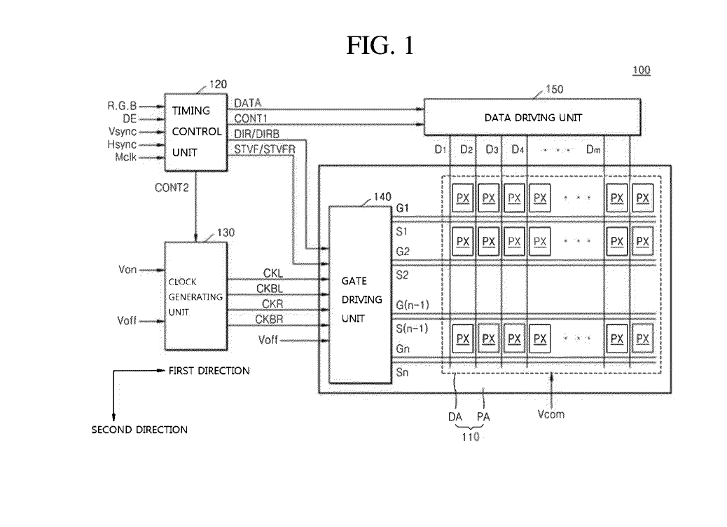

FIG. 1 is a schematic circuit diagram of the display device 100 according to the embodiment of the present invention. Referring to FIG. 1, the display device 100 according to an embodiment may include a liquid crystal panel 110 which displays images, a timing control unit 120, a clock generating unit 130, a gate driving unit 140, and a plurality of pixels PX.

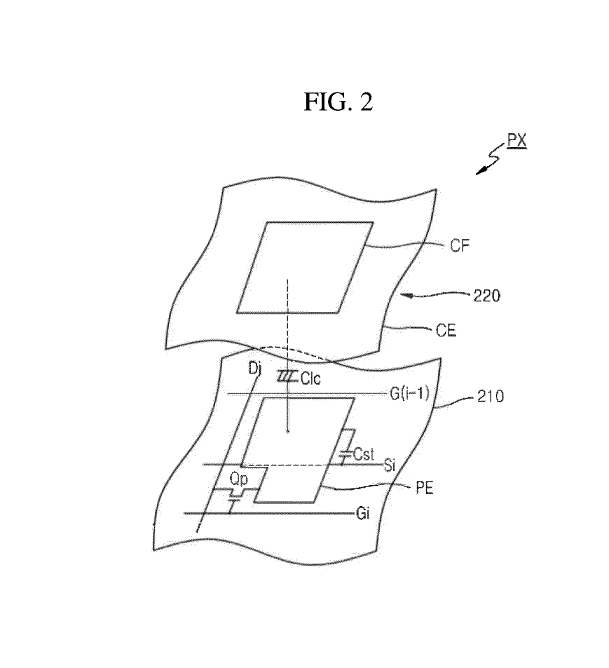

The liquid crystal panel 110 may display images. The liquid crystal panel 110 may be divided into a display area DA where images are displayed and a non-display area PA where no images are displayed. As shown in FIG. 2, the display area DA may include a first substrate 210, a second substrate 220, and a liquid crystal layer (not shown) interposed between the first substrate 210 and the second substrate 220. A plurality of gate lines G1 through Gn, a plurality of storage lines S1 through Sn, a plurality of data lines D1 through Dm, a pixel-switching device Qp and a pixel electrode PE are formed on the first substrate 210, and a color filter CF and a common electrode CE are formed on the second substrate 220.

The gate lines G1 through Gn may extend in a first direction to be parallel to each other, and the storage lines S1 through Sn may extend in the first direction to correspond to the gate lines G1 through Gn, respectively. The data lines D1 through Dm may extend in a second direction to be parallel to each other. In some embodiments, the gate lines G1 through Gn and the storage lines S1 through Sn may extend in the second direction, and the data lines D1 through Dm may extend in the first direction. The first and second directions may be perpendicular to one another.

FIG. 2 is a circuit diagram of a pixel PX according to an embodiment of the present invention. Referring to FIGS. 1 and 2, each pixel PX may be connected to, for example, an i^{th} (i is a natural number of 1 to n) gate line Gi and a j^{th} (j is a natural number of 1 to m) data line Dj. In addition, each pixel PX may include the pixel-switching device Qp which includes a gate electrode connected to the i^{th} gate line Gi, a first electrode connected to the j^{th} data line Dj and a second electrode connected to the pixel electrode PE, a liquid crystal capacitor Clc which is coupled to the second electrode of the pixel-switching device Qp by the pixel electrode PE, and a storage capacitor Cst.

The liquid crystal capacitor Clc may be formed by two electrodes, i.e., the pixel electrode PE of the first substrate 210 and the common electrode CE of the second substrate 200. The liquid crystal capacitor Clc may include the liquid crystal layer which is interposed between the two electrodes and functions as a dielectric. A common voltage Vcom may be applied to the common electrode CE. The light transmittance of the liquid crystal layer may be adjusted according to a voltage applied to the pixel electrode PE, thereby controlling the luminance of each pixel PX.

The pixel electrode PE may be coupled to the j^{th} data line Dj by the pixel-switching device Qp. The gate electrode of the pixel-switching device Qp may be connected to the i^{th} gate line Gi. When a gate-on voltage Von is applied to the i^{th} gate line Gi, the pixel-switching device Qp may transmit a data signal received through the j^{th} data line Dj to the pixel electrode PE. The pixel-switching device Qp may be a thin-film transistor made of amorphous silicon.

An end of the storage capacitor Cst may be coupled to the liquid crystal capacitor Clc, and the other end of the storage capacitor Cst may be coupled to an i^{th} storage line Si. A color filter CF may be formed in a region of the common electrode CE of the second substrate 220.

The non-display area PA is where no images are displayed. The first substrate 210 is wider than the second substrate 220. Thus, the display device 100 may include regions where no images are displayed. According to an embodiment of the present invention, the gate driving unit 140 may be disposed in a region of the first substrate 210 which corresponds to the non-display area PA.

The timing control unit 120 may receive, from an external graphic controller (not shown), input image signals R, G and B and input control signals for controlling the display of the input image signals R, G and B and provide image data signals DATA and data driving unit control signals CONT1 to the data driving unit 150. Specifically, the timing control unit 120 may receive input control signals, such as a horizontal synchronization signal Hsync, a main clock signal Mclk and a data enable signal DE, and output the data driving unit control signals CONT1. The data driving unit control signals CONT1 are used to control the operation of the data driving unit 150 and include a horizontal start signal for starting the operation of the data driving unit 150 and a load signal for instructing the output of data voltages.

The data driving unit 150 may receive the image data signals DATA and the data driving unit control signals CONT1 and provide data signals, which correspond to the image data signals DATA, to the data lines D1 through Dm, respectively. The data driving unit 150 may be connected to the liquid crystal panel 110 in the form of a tape carrier package (TCP) or may be formed in the non-display area PA of the liquid crystal panel 110.

The timing control unit 120 may provide clock generation control signals CONT2 to the clock generating unit 130 and provide first and second start pulses STVF and STVFR and first and second scanning direction control signals DIR and DIRB to the gate driving unit 140. The clock generation control signals CONT2 may include a gate clock signal which determines when to output the gate-on voltage Von and an output enable signal which determines a pulse width of the gate-on voltage Von. The first and second scanning direction control signals DIR and DIRB may control the order of turn-on sections, i.e., sections within which the gate-on voltage Von is applied to the gate lines G1 through Gn. For example, when the first scanning direction control signal DIR is at a high level while the second scanning direction control signal DIRB is at a low level, the turn-on section is provided to the first gate line G1 and then to the second through n^{th} gate lines G2 through Gn, sequentially. Alternatively, when the first scanning direction control signal DIR is at a low level while the second scanning direction control signal DIRB is at a high level, the turn-on section is provided to the nth gate line Gn and then to the (n−1)^{th} through first gate lines G(n−1) through G1, sequentially.

The clock generating unit 130 may output a first clock signal CKL, a first inverted clock signal CKBL, a second clock signal CKR, and a second inverted clock signal CKBR using the clock generation control signals CONT2. The first inverted clock signal CKBL may be an inverted signal of the first clock signal CKL or a signal with a delay of half a period. The second inverted clock signal CKBR may be an inverted signal of the second clock signal CKR or a signal with a delay of half a period. Each of the first and second clock signals CKL and CKR may have 4 horizontal periods (4H), and the second clock signal CKR may have a delay of one horizontal period (1H) from the first clock signal CKL.

The gate driving unit 140 may provide a gate signal to each of the gate lines G1 through Gn using the first and second start pulses STVF and STVFR, the first and second scanning direction control signals DIR and DIRB, the first and second clock signals CKL and CKR, the first and second inverted clock signals CKBL and CKBR, and a gate-off voltage Voff.

The structure of the display device 100 described above with reference to FIGS. 1 and 2 is merely an example. The structure of the display device 100 is not limited to the embodiment of FIGS. 1 and 2 and may vary depending on the embodiment. For example, the detailed structure of each pixel PX can be modified in various ways. Also, the type of signals input to or output from the timing control unit 120, the clock generating unit 130, the gate driving unit 140 and the data driving unit 150 can vary depending on the embodiment.

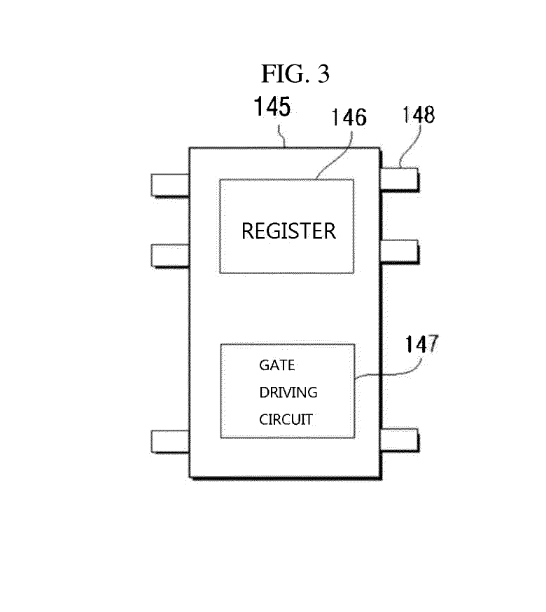

The gate driving unit 140 according to the current embodiment may include one or more gate drivers 145 (shown in FIG. 3). The gate drivers 145 may be implemented as, for example, integrated circuits (ICs).

FIG. 3 is a block diagram of a gate driver 145 according to an embodiment of the present invention. Referring to FIG. 3, the gate driver 145 according to the current embodiment may include a register 146 which stores data, a gate driving circuit 147 which generates driving signals based on the data stored in the register 146, and one or more output terminals 148 which output the driving signals generated by the gate driving circuit 147.

The register 146 may store data. The register 146 is a small memory device and can have various sizes according to its purpose and use. The register 146 may have a size of, for example, 4 bytes (32 bits) or 32 bytes (256 bits).

The gate driving circuit 147 may generate driving signals based on the data stored in the register 146. Based on the data stored in the register 146, the gate driving circuit 147 may generate a driving signal that is to be output through each of the output terminals 148. Therefore, the gate driving circuit 147 may generate a driving signal based on data corresponding to each of the output terminals 148 among the data stored in the register 146.

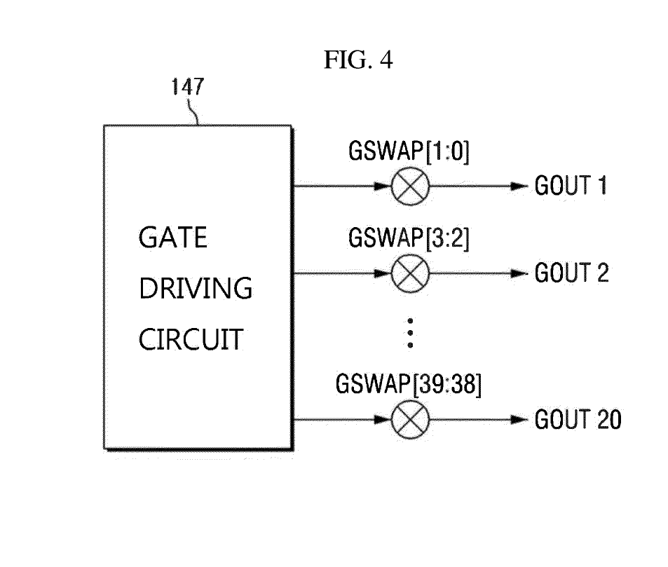

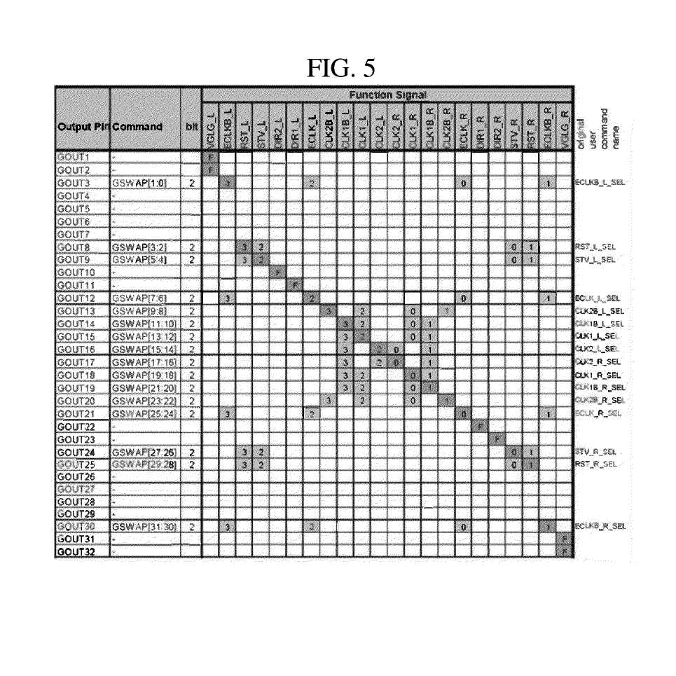

FIG. 4 is a conceptual diagram illustrating a process of generating a driving signal that is to be output through each of the output terminals 148 of the gate driver 145 according to an embodiment of the present invention. FIG. 5 is a table showing a driving signal output from each of the output terminals 148 of the gate driver 145 based on the data stored in the register 146 according to an embodiment of the present invention.

Referring to FIGS. 4 and 5, to generate a driving signal that is to be output through an output terminal 148, the gate driving circuit 147 may refer to 2-bit data corresponding to the output terminal 148 among the data stored in the register 146.

In the embodiment of FIG. 4, the register 146 may consist of a total of 40 bits ranging from a 0^{th} bit to a 39^{th} bit. To generate a driving signal that is to be output through an output terminal GOUT1, the gate driving circuit 147 may refer to the 0^{th} and 1^{st} bits of the register 146. Similarly, to generate a driving signal that is to be output through an output terminal GOUT2, the gate driving circuit 147 may refer to the 2^{nd} and 3^{rd} bits of the register 146. To generate a driving signal that is to be output through an output terminal GOUT20, the gate driving circuit 147 may refer to the 38^{th} and 39^{th} bits of the register 146. In FIG. 4, GSWAP[n:m] may indicate that bits from an m^{th} bit to an n^{th} bit of the register 146 are referred to.

In the embodiment of FIG. 5, the register 146 may consist of a total of 32 bits ranging from a 0^{th} bit to a 31^{st} bit. An Output Pin column of FIG. 5 provides a list of the output terminals 148. A Command column shows from which bit of the register 146 to which bit of the register 146 are referred to by the gate driving circuit 147 to generate a driving signal that is to be output through each of the output terminals 148. A Bit column shows the number of bits referred to by the gate driving circuit 147 to generate a driving signal that is to be output through each of the output terminals 148.

In the embodiment of FIG. 5, the gate driving circuit 147 refers to the register 146 in order to generate driving signals that are to be output through output terminals GOUT3, GOUTS, GOUT9, GOUT12 through GOUT21, GOUT24, GOUT25 and GOUT30 from among the output terminals 148. Thus, the gate driving circuit 147 may not refer to the register 146 for the other output terminals 148. In this case, driving signals output from the other output terminals 148 may be constant or may not be defined. In the embodiment of FIG. 5, the register 146 may have a size of 32 bits. However, the register 146 may also have a size of 64 bits or more such that 2-bit data corresponding to each of the output terminals GOUT1 through GOUT32 can be stored in the register 146.

In the embodiment of FIG. 5, the gate driving circuit 147 refers to 2 bits of data in order to generate a driving signal that is to be output through each of the output terminals 148. However, the number of bits referred to may vary depending on the embodiment. For example, 1 bit or 8 bits may be referred to. In addition, in some embodiments, the gate driving circuit 147 may refer to data of different sizes in order to generate driving signals that are to be output through different output terminals 148, respectively.

A Function Signal column may show driving signals corresponding to the data stored in the register 146. In the embodiment of FIG. 5, the gate driving circuit 147 refers to 2 bits of data in order to generate a driving signal that is to be output through each of the output terminals 148. Therefore, four types of data may each be stored in 2 bits and may be represented by 0, 1, 2, and 3, respectively.

The Function Signal column may show the type of a driving signal generated according to the type of data stored in a 2-bit storage space which corresponds to each of the output terminals 148 from among the storage space of the register 146. For example, if zero (0) is stored in a 2-bit storage space consisting of the 2^{nd} and 3^{rd} bits of the register 146, a driving signal STV_R may be generated by the gate driving circuit 147 and output through the output terminal GOUT8. If one (1) is stored in the above storage space, a driving signal RST _R may be generated by the gate driving circuit 147 and output through the output terminal GOUT8. If two (2) is stored in the above storage space, a driving signal STV_L may be generated by the gate driving circuit 147 and output through the output terminal GOUT8. If three (3) is stored in the above storage space, a driving signal RST_L may be generated by the gate driving circuit 147 and output through the output terminal GOUT8.

In the embodiment of FIG. 5, the gate driving circuit 147 refers to 2 bits of data in order to generate a driving signal that is to be output through each of the output terminals 148. Therefore, four types of driving signals may be generated according to the type of data stored in a 2-bit storage space. In some embodiments, the gate driving circuit 147 may refer to every 4 bits of data. In this case, 16 types of data may each be stored in 4 bits. Accordingly, 16 types of driving signals may be generated according to the type of data stored in a 4-bit storage space which corresponds to each of the output terminals 148 among the storage space of the register 146.

In some embodiments, the driving signal generated may be generated by the user by setting the corresponding value at the register included in the gate driver. The user may determine the driving signal desired, and the driving signal is then mapped to and output from a terminal of the gate driver. Therefore, the compatibility of the gate driver is increased. The driving signal determined may be one of the signals, such as for example, STV_R, STV_L, RST_R, RST_L, CLK1_R, CLK2B_R and the like listed in FIG. 5.

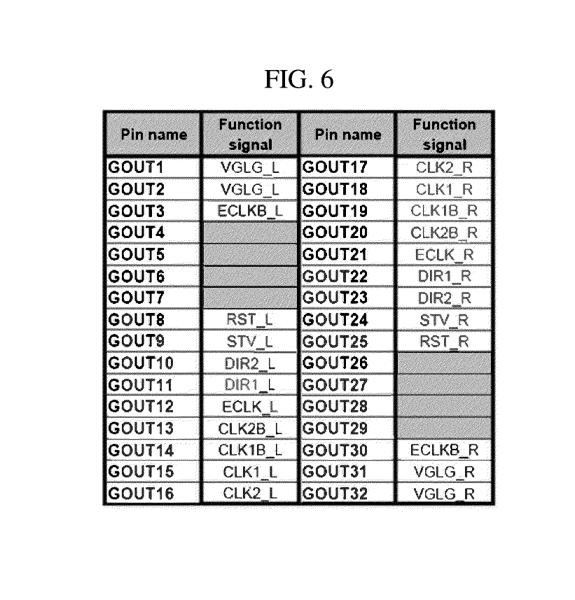

FIG. 6 is a table showing a default value of a driving signal output from each of the output terminals 148 of the gate driver 145 according to an embodiment of the present invention. To output driving signals as shown in FIG. 6, 3,3,2,2,3,3,2,2,0,0,1,1,0,0,1,1 may be stored in every 2 bits of the register 146.

When the gate driver 145 set as described above is used, an error may occur during the operation of the LCD due to a compatibility problem related to a driving signal output from each of the output terminals 148. In this case, a driving signal output from an output terminal 148 can be changed simply by changing data stored in the register 146 without having to replace the gate driver 145. In this way, the error can be easily solved.

A gate driver according to an embodiment of the present invention can output an output signal through each output terminal.

According to an embodiment of the present invention, the compatibility of the gate driver can be increased.

According to an embodiment of the present invention, when an error occurs during the operation of an LCD due to a compatibility problem of the gate driver, it can be easily solved without the need to replace the gate driver.

While the present invention has been particularly shown and described with reference to certain embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A gate driver comprising:
a register configured to store data;
a gate driving circuit configured to generate driving signals based on the data stored in the register; and
one or more output terminals each configured to output a driving signal generated by the gate driving circuit.

2. The gate driver of claim 1, wherein the register has a size of 1 bit to 32 bytes.

3. The gate driver of claim 1, wherein the gate driving circuit is configured to generate a driving signal that is to be output through each of the output terminals based on data corresponding to each of the output terminals from among the data stored in the register.

4. The gate driver of claim 1, wherein the gate driving circuit is configured to generate a driving signal that is to be output through an output terminal based on data corresponding to the output terminal from among the data stored in the register, wherein the data corresponding to the output terminal has a size of 1 bit to 8 bits.

5. The gate driver of claim 1, wherein the gate driving circuit is configured to generate a driving signal that is to be output through an output terminal based on data corresponding to the output terminal from among the data stored in the register, wherein when the data corresponding to the output terminal is changed to a different value, the driving signal output through the output terminal is changed to a different type.

6. The gate driver of claim 1, comprising two or more output terminals, wherein one or more of the output terminals are configured to output two or more different types of driving signals based on the data stored in the register, and one or more of the output terminals are configured to output one type of driving signal regardless of the data stored in the register.

7. The gate driver of claim 1, wherein the gate driving circuit is configured to generate a driving signal that is to be output through a first output terminal based on first data from among the data stored in the register and to generate a driving signal that is to be output through a second output terminal based on second data from among the data stored in the register, wherein the first data and the second data have different sizes.

8. A gate driver comprising:
a register configured to store data;
a gate driving circuit configured to generate two or more different types of driving signals based on the data stored in the register; and
one or more output terminals configured to output the driving signals generated by the gate driving circuit and output two or more different types of driving signals based on the data stored in the register.

9. A display device comprising:
a liquid crystal panel comprising one or more gate lines, one or more data lines, and one or more pixels disposed in regions where the gate lines intersect the data lines;
a timing control unit configured to generate a control signal for driving the liquid crystal panel;
a gate driving unit configured to receive the control signal and to output a gate signal to each of the gate lines in response to the control signal; and
a data driving unit configured to receive the control signal and apply a data voltage to each of the data lines in response to the control signal,
wherein the gate driving unit comprises:
a register configured to store data;
a gate driving circuit configured to generate driving signals based on the data stored in the register; and
one or more output terminals configured to output the driving signals generated by the gate driving circuit.

10. The display device of claim 9, wherein one or more of the output terminals output two or more different types of driving signals based on the data stored in the register.

11. The display device of claim 9, wherein the gate driving unit comprises two or more output terminals, wherein one or more of the output terminals are configured to output two or more different types of driving signals based on the data stored in the register, and one or more of the output terminals are configured to output one type of driving signal regardless of the data stored in the register.

12. The display device of claim 9, wherein the gate driving circuit is configured to generate a driving signal that is to be output through a first output terminal based on first data from among the data stored in the register and to generate a driving signal that is to be output through a second output terminal based on second data from among the data stored in the register, wherein the first data and the second data have different sizes.

13. A display device comprising:
a liquid crystal panel comprising one or more gate lines, one or more data lines, and one or more pixels disposed in regions where the gate lines intersect the data lines;
a timing control unit configured to generate a control signal for driving the liquid crystal panel;
a gate driving unit configured to receive the control signal and to output a gate signal to each of the gate lines in response to the control signal; and
a data driving unit configured to receive the control signal and to apply a data voltage to each of the data lines in response to the control signal,
wherein the gate driving unit comprises:
a register configured to store data;
a gate driving circuit configured to generate two or more different types of driving signals based on the data stored in the register; and
one or more output terminals configured to output the driving signals generated by the gate driving circuit.

14. The display device of claim 13, wherein the one or more output terminals are further configured to output two or more different types of driving signals based on the data stored in the register.
